(19) United States
(12) Patent Application Publication
(10) Pub. No.: US 2026/0136427 A1
(43) Pub. Date: May 14, 2026

(54) COMMUNICATION APPARATUS, BASE STATION, AND COMMUNICATION METHOD

(71) Applicant: DENSO CORPORATION, Kariya-city (JP)

(72) Inventor: Tomoyuki YAMAMOTO, Kariya-city (JP)

(21) Appl. No.: 19/442,596

(22) Filed: Jan. 7, 2026

Related U.S. Application Data
(63) Continuation of application No. PCT/JP2024/024724, filed on Jul. 9, 2024.

(30) Foreign Application Priority Data
Jul. 12, 2023 (JP) 2023-114678

(51) Int. Cl. H04W 76/20; H04L 5/00; H04W 64/00

(52) U.S. Cl. CPC H04W 76/20; H04L 5/0053; H04W 64/00

(57) ABSTRACT

A communication apparatus comprises: a receiver configured to receive a radio resource control (RRC) reconfiguration message including information for configuring a distance threshold for triggering path information update notification based on a distance and a time threshold for triggering the path information update notification based on a time, from a base station; and a transmitter configured to transmit an RRC reconfiguration complete message including information indicating that the path information is available to the base station in response to reception of the RRC reconfiguration message. The receiver is configured to receive a UE information request message including configuration information regarding report of the path information, from the base station. The transmitter is configured to transmit a UE information response message including the path information to the base station in response to reception of the UE information request message. The transmitter is configured to transmit a UE assistance information message including the information indicating that the path information is available to the base station based on determination based on the distance threshold regardless of configuration of the time threshold.

### CROSS-REFERENCE TO RELATED APPLICATION

The present application is a continuation application of international Patent Application No. PCT/JP2024/024724, filed on Jul. 9, 2024, which designated the U.S., and claims the benefit of priority of Japanese Patent Application No. 2023-114678, filed on Jul. 12, 2023, the entire contents of which are incorporated herein by reference.

### TECHNICAL FIELD

The present disclosure relates to a communication apparatus, a base station, and a communication method used in a mobile communication system.

### BACKGROUND ART

Release 17 of the technical specification (TS) for the 4th generation system (4G/LTE: Long Term Evolution) defined by 3GPP (registered trademark; the same applies hereinafter) (3rd Generation Partnership Project), which is a mobile communication system standardization project, defines that when a communication apparatus has available path information (specifically, flight path information), the communication apparatus includes availability information (specifically, flightPathInfoAvailable) in an RRC message (for example, RRC connection reconfiguration complete message) transmitted in response to a radio resource control (RRC) message from a base station. The base station that has received the availability information can acquire path information from the communication apparatus by requesting the path information from the communication apparatus.

In recent years, regarding NR (New Radio), an operation in a case where path information is updated in a communication apparatus after the path information is reported from the communication apparatus to a base station has been discussed. Currently, it has been agreed that a network can configure a communication apparatus to trigger path information update notification (flightpath update notification) based on a configured distance difference (for example, a spatial difference), or a time difference that is configured if it is configured to report a timestamp (see, for example, Non Patent Literature 1). The base station that has received the update notification can acquire the updated path information from the communication apparatus by requesting the path information from the communication apparatus.

### CITATION LIST

### Non Patent Literature

Non Patent Literature 1: 3GPP TSG-RAN WG2 Meeting #122, R2-2306543, “Report from Session on NES, UAV, Rel-15-17 UP, Rel-17 Small Data, IIoT/URLLC, and RACH partitioning”

### SUMMARY OF INVENTION

A communication apparatus according to a first aspect comprises: a receiver configured to receive a radio resource control (RRC) reconfiguration message including information for configuring a distance threshold for triggering path information update notification based on a distance and a time threshold for triggering the path information update notification based on a time, from a base station; and a transmitter configured to transmit an RRC reconfiguration complete message including information indicating that the path information is available to the base station in response to reception of the RRC reconfiguration message. The receiver is configured to receive a UE information request message including configuration information regarding report of the path information, from the base station. The transmitter is configured to transmit a UE information response message including the path information to the base station in response to reception of the UE information request message. The transmitter is configured to transmit a UE assistance information message including the information indicating that the path information is available to the base station based on determination based on the distance threshold regardless of configuration of the time threshold.

A base station according to a second aspect comprises: a transmitter configured to transmit a radio resource control (RRC) reconfiguration message including information for configuring a distance threshold for triggering path information update notification based on a distance and a time threshold for triggering the path information update notification based on a time to a communication apparatus; and a receiver configured to receive an RRC reconfiguration complete message including information indicating that the path information is available from the communication apparatus in response to transmission of the RRC reconfiguration message. The transmitter is configured to transmit a UE information request message including configuration information regarding report of the path information to the communication apparatus. The receiver is configured to receive a UE information response message including the path information from the communication apparatus in response to transmission of the UE information request message. The receiver is configured to receive a UE assistance information message that includes the information indicating that the path information is available and is based on determination based on the distance threshold from the communication apparatus regardless of configuration of the time threshold.

A communication method according to a third aspect is a communication method executed by a communication apparatus. The communication method comprises: a step of receiving a radio resource control (RRC) reconfiguration message including information for configuring a distance threshold for triggering path information update notification based on a distance and a time threshold for triggering the path information update notification based on a time, from a base station; a step of transmitting an RRC reconfiguration complete message including information indicating that the path information is available to the base station in response to reception of the RRC reconfiguration message; a step of receiving a UE information request message including configuration information regarding report of the path information, from the base station; a step of transmitting a UE information response message including the path information to the base station in response to reception of the UE information request message; and a step of transmitting a UE assistance information message including the information indicating that the path information is available to the base station based on determination based on the distance threshold regardless of configuration of the time threshold.

### BRIEF DESCRIPTION OF DRAWINGS

Objects, features, advantages, and the like of the present disclosure will become more apparent from the following detailed description with reference to the accompanying drawings.

FIG. 1 is a diagram illustrating a configuration of a mobile communication system according to an embodiment.

FIG. 2 is a diagram illustrating a configuration example of a protocol stack according to the embodiment.

FIG. 3 is a sequence diagram for describing an assumed scenario.

FIG. 4 is a diagram illustrating a configuration of a user equipment (UE) according to the embodiment.

FIG. 5 is a diagram illustrating a configuration of a base station according to the embodiment.

FIG. 6 is a sequence diagram (part 1) for describing an operation example according to the embodiment.

FIG. 7 is a diagram for describing an example of an information element of an operation example according to the embodiment.

FIG. 8 is a sequence diagram (part 2) for describing an operation example according to the embodiment.

FIG. 9 is a sequence diagram for describing a first operation example regarding determination of update notification according to the embodiment.

FIG. 10 is a sequence diagram for describing a second operation example regarding determination of update notification according to the embodiment.

FIG. 11 is a sequence diagram for describing a third operation example regarding determination of update notification according to the embodiment.

### DESCRIPTION OF EMBODIMENTS

A mobile communication system according to an embodiment will be described with reference to the drawings. In the description of the drawings, the same or similar parts are denoted by the same or similar reference numerals.

In the current discussion, it is only mentioned that the condition for triggering the path information update notification is the configured distance difference or time difference, and there is a concern that the communication apparatus cannot perform the path information update notification at an appropriate timing.

Therefore, an object of the present disclosure is to provide a communication apparatus, a base station, and a communication method that enable path information update notification at an appropriate timing.

### (System Configuration)

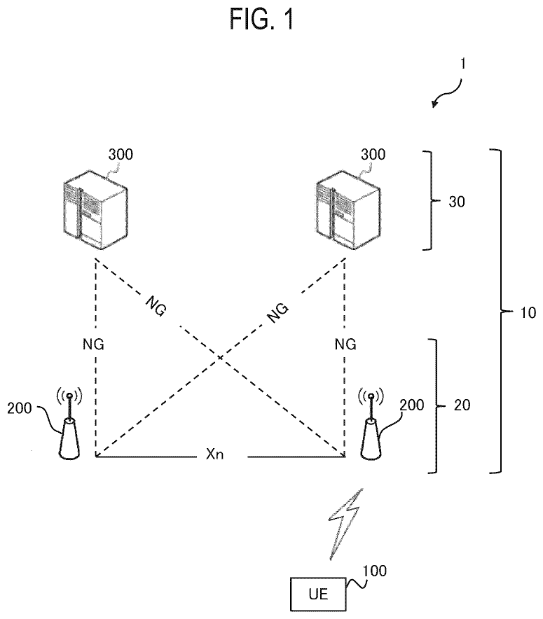

First, a configuration of a mobile communication system 1 according to the present embodiment will be described with reference to FIG. 1. The mobile communication system 1 is, for example, a system conforming to a technical specification (Technical Specification: TS) of 3GPP. Hereinafter, as the mobile communication system 1, a 5th generation system (5th Generation System: 5G system) of the 3GPP standard, that is, a mobile communication system based on NR (NR (New Radio) Radio Access) will be described as an example.

The mobile communication system 1 includes a network 10 and a user equipment (User Equipment: UE) 100 that communicates with the network 10. The network 10 includes NG-RAN (Next Generation Radio Access Network) 20, which is a 5G radio access network, and a 5GC (5G Core Network) 30, which is a 5G core network.

The UE 100 is an example of a communication apparatus. The UE 100 may be a mobile radio communication apparatus. The UE 100 may be a communication apparatus that communicates via a base station 200. The UE 100 may be an apparatus used by a user. The UE 100 may be a user equipment defined in the 3GPP technical specification. The UE 100 is, for example, a mobile apparatus such as a mobile phone terminal such as a smartphone, a tablet terminal, a laptop PC, a communication module, or a communication card. The UE 100 may be a vehicle (for example, a car or a train) or an apparatus provided in the vehicle. The UE 100 may be a transport body other than a vehicle (for example, a ship or an airplane) or an apparatus provided in the transport body. The UE 100 may be a sensor or an apparatus provided in the sensor. Note that the UE 100 may be referred to as another term such as a terminal, a terminal apparatus, a mobile station, a mobile terminal, a mobile apparatus, a mobile unit, a subscriber station, a subscriber terminal, a subscriber apparatus, a subscriber unit, a wireless station, a wireless terminal, a wireless apparatus, a wireless unit, a remote station, a remote terminal, a remote apparatus, or a remote unit. In addition, the UE 100 is an example of a terminal, and the terminal may include a factory apparatus or the like.

The UE 100 (that is, the communication apparatus) may be an unmanned aerial vehicle (Unmanned aerial vehicle: UAV) or a communication module mounted on the UAV. Note that the present embodiment may be applied not only to the UAV but also to any vehicle such as manned and unmanned vehicles including vehicles and autonomous vehicles/semi-autonomous vehicles, as well as manned and unmanned ships including ships and autonomous ships/semi-autonomous ships. That is, the present embodiment can be applied to any vehicle including the above-described vehicle.

The NG-RAN 20 includes a plurality of base stations 200. Each base station 200 manages at least one cell. The cell configures a minimum unit of a communication area. One cell belongs to one frequency (carrier frequency). The term “cell” may indicate a radio communication resource, and may also indicate a communication object of the UE 100. Each base station 200 can perform radio communication with the UE 100 that exists in its own cell. The base station 200 communicates with the UE 100 using a protocol stack of RAN. Details of the protocol stack are described below. One base station 200 is connected to another base station 200 (may be referred to as a neighboring base station) via an Xn interface. The base station 200 communicates with the neighboring base station via the Xn interface. The base station 200 provides NR user plane and control plane protocol terminations toward the UE 100 and is connected to the 5GC 30 via an NG interface. Such a base station 200 of NR may be referred to as a gNodeB (gNB). Note that the operation of the base station 200 may be replaced with the operation of the network 10.

The 5GC 30 includes a core network apparatus 300. The core network apparatus 300 includes, for example, AMF (Access and Mobility Management Function) and/or UPF (User Plane Function). The AMF performs mobility management of the UE 100. The UPF provides a feature specialized for U-plane processing. The AMF and the UPF are connected to the base station 200 via the NG interface.

### (Configuration Example of Protocol Stack)

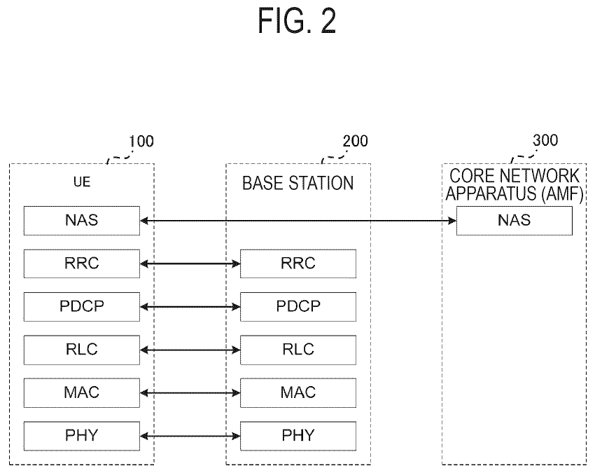

Next, a configuration example of the protocol stack according to the present embodiment will be described with reference to FIG. 2.

A protocol of a radio section between the UE 100 and the base station 200 includes a physical (PHY) layer, an MAC (Medium Access Control) layer, an RLC (Radio Link Control) layer, a PDCP (Packet Data Convergence Protocol) layer, and an RRC (Radio Resource Control) layer.

The PHY layer performs coding and decoding, modulation and demodulation, antenna mapping and demapping, and resource mapping and demapping. Data and control information are transmitted between the PHY layer of the UE 100 and the PHY layer of the base station 200 via a physical channel.

The MAC layer performs priority control of data, retransmission processing by hybrid ARQ (HARQ), random access procedure, and the like. Data and control information are transmitted between the MAC layer of the UE 100 and the MAC layer of the base station 200 via a transport channel. The MAC layer of the base station 200 includes a scheduler. The scheduler determines uplink and downlink transport formats (transport block size, modulation and coding scheme (MCS)) and resources to be allocated to the UE 100.

The RLC layer transmits data to the RLC layer on a reception side using features of the MAC layer and the PHY layer. Data and control information are transmitted between the RLC layer of the UE 100 and the RLC layer of the base station 200 via a logical channel.

The PDCP layer performs header compression and decompression and encryption and decryption.

An SDAP (service data adaptation protocol) layer may be provided as an upper layer of the PDCP layer. The SDAP (service data adaptation protocol) layer performs mapping between an IP flow as a unit of QoS (quality of service) control by a core network and a radio bearer as a unit of QoS control by an AS (access stratum).

The RRC layer controls the logical channel, the transport channel, and the physical channel in response to establishment, reestablishment, and release of the radio bearer. RRC signaling for various configurations is transmitted between the RRC layer of the UE 100 and the RRC layer of the base station 200. When an RRC connection exists between the RRC layer of the UE 100 and the RRC layer of the base station 200, the UE 100 is in an RRC connected state. When no RRC connection exists between the RRC layer of the UE 100 and the RRC layer of the base station 200, the UE 100 is in an RRC idle state. When an RRC connection between the RRC layer of the UE 100 and the RRC layer of the base station 200 is suspended, the UE 100 is in an RRC inactive state.

An NAS layer located above the RRC layer in the UE 100 performs session management and mobility management of the UE 100. NAS signaling is transmitted between the NAS layer of the UE 100 and the NAS layer of the core network apparatus 300.

Note that the UE 100 includes an application layer and the like in addition to a protocol of a radio interface.

### (Radio Frame Configuration)

In the 5G system, downlink transmission and uplink transmission are configured in a radio frame of 10 ms duration. For example, the radio frame includes 10 subframes. For example, one subframe may be 1 ms. One subframe may include one or more slots. For example, the number of symbols configuring one slot is 14 for a normal CP (cyclic prefix) and 12 for an extended CP. The number of slots configuring one subframe changes depending on a configuration of a sub-carrier spacing. For example, for the normal CP, when the sub-carrier spacing is configured as 15 kHz, the number of slots per subframe is one (that is, 14 symbols), when the sub-carrier spacing is configured as 30 kHz, the number of slots per subframe is two (that is, 28 symbols), when the sub-carrier spacing is configured as 60 kHz, the number of slots per subframe is four (that is, 56 symbols), and when the sub-carrier spacing is configured as 120 kHz, the number of slots per subframe is eight (that is, 128 symbols). For the extended CP, when the sub-carrier spacing is configured as 60 kHz, the number of slots per subframe is four (that is, 48 symbols). That is, the number of slots configuring one subframe is determined based on the sub-carrier spacing configured by the base station 200. The number of symbols configuring one subframe is determined based on the sub-carrier spacing configured by the base station 200. That is, the number of symbols configuring a subframe of 1 ms is determined based on the sub-carrier spacing configured by the base station 200, and a length of each symbol (a length in a time direction) changes.

### (Assumed Scenario)

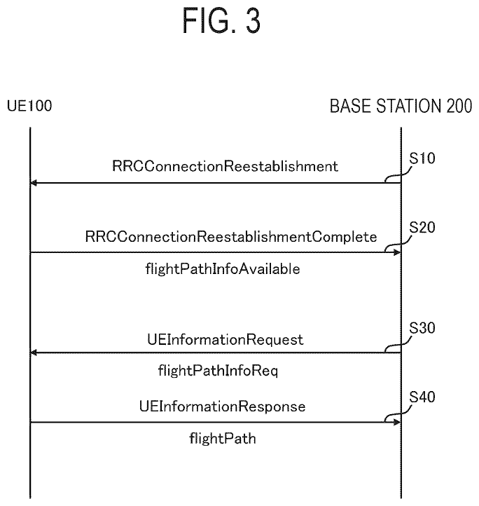

An assumed scenario in the mobile communication system 1 according to the embodiment will be described with reference to FIG. 3. Release 17 of 3GPP which is a mobile communication system standardization project defines that when the UE 100 has flight path information (flight path information), the RRC message transmitted as a response to the RRC message from the base station 200 includes availability information (specifically, flightPathInfoAvailable).

As illustrated in FIG. 3, in step S10, the base station 200 transmits, for example, an RRC connection reestablishment (RRCConnectionReestablishment) message to the UE 100. The UE 100 receives the RRC connection reestablishment message from the base station 200.

In step S20, after the reestablishment of the RRC connection is normally completed, the UE 100 transmits an RRC connection reestablishment complete (RRCConnectionReestablishmentComplete) message to the base station 200 as a response to the RRC connection reestablishment message. The base station 200 receives the RRC connection reestablishment complete message. If the UE 100 has available flight path information, the UE 100 may include availability information in the RRC connection reestablishment complete message.

In step S30, the base station 200 transmits a UE information request (UEInformationRequest) message including a flight path information request (flightPathInfoReq) to the UE 100. The UE 100 receives a UE information request message from the base station 200.

In step S40, the UE 100 transmits a UE information response (UEInformationResponse) message including the flight path information (flightPath) to the base station 200 based on the flight path information request. The base station 200 receives the UE information response message from the UE 100. In this manner, the base station 200 that has received the availability information can acquire the flight path information from the UE 100 by requesting the flight path information from the UE 100. As a result, the network 10 can appropriately perform communication control (for example, handover control, beamforming control, and the like) with the communication apparatus based on the updated flight path information.

In recent years, regarding NR (New Radio), an operation in a case where path information is updated in the UE 100 after the path information is reported from the UE 100 to the base station 200 has been discussed. Currently, it has been agreed that the network 10 can configure the UE 100 to trigger path information update notification (flightpath update notification) based on a configured distance difference (for example, a spatial difference), or a time difference that is configured if it is configured to report a timestamp. The base station 200 that has received the update notification can acquire the updated path information from the UE 100 by requesting the path information from the UE 100.

In the current discussion, it is only mentioned that the condition for triggering the path information update notification is the configured distance difference or time difference, and there is a concern that the UE 100 cannot perform the path information update notification at an appropriate timing.

For example, after performing the path information update notification due to the distance difference or the time difference, there is a possibility that the UE 100 may miss an opportunity to perform path information update notification. For example, in a case where the network 10 (base station 200) has failed to normally receive the path information update notification transmitted from the UE 100 due to, for example, deterioration of the radio condition or the like, (report of) the path information cannot be requested from the UE 100. In this case, since the UE 100 has already notified of the path information update, there is a risk that the UE 100 may consider that the base station 200 has not requested the UE 100 to report the path information. As a result, the path information cannot be updated unintentionally for the network 10 and the UE 100, and there is a concern that the UE 100 cannot perform path information update notification at an appropriate timing. In addition, since the path information update is not specifically defined, there is a concern that the UE 100 cannot perform path information update notification at an appropriate timing. In an embodiment to be described below, an operation for enabling path information update notification at an appropriate timing will be described.

### (Configuration of UE)

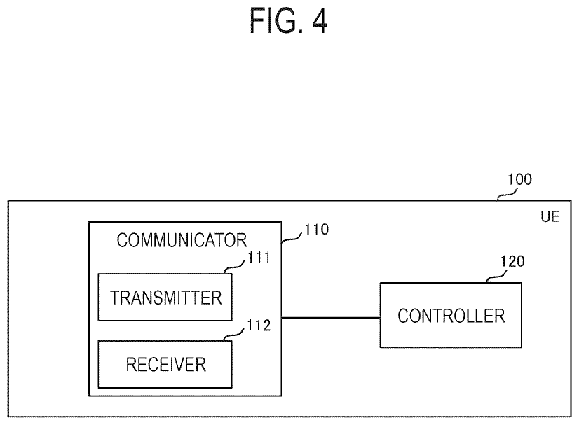

A configuration of the UE 100 according to the embodiment will be described with reference to FIG. 4. The UE 100 includes a communicator 110 and a controller 120.

The communicator 110 performs radio communication with the base station 200 by transmitting and receiving a radio signal to and from the base station 200. The communicator 110 includes at least one transmitter 111 and at least one receiver 112. The transmitter 111 and the receiver 112 may include a plurality of antennas and RF circuits. The antenna converts a signal into a radio wave and emits the radio wave to space. The antenna receives a radio wave from space and converts the radio wave into a signal. The RF circuit performs analog processing of a signal transmitted and received via the antenna. The RF circuit may include a high frequency filter, an amplifier, a modulator, a low pass filter, and the like.

The controller 120 performs various types of control in the UE 100. The controller 120 controls communication with the base station 200 via the communicator 110. The operation of the UE 100 described above and described below may be an operation controlled by the controller 120. The controller 120 may include at least one processor capable of executing a program and a memory that stores the program. The processor may perform the program and perform the operation of the controller 120. The controller 120 may include a digital signal processor that performs digital processing of a signal transmitted and received via the antenna and the RF circuit. The digital processing includes processing of the protocol stack of the RAN. Note that the memory stores the program to be performed by the processor, parameters related to the program, and data related to the program. The memory may include at least one of a ROM (read only memory), an EPROM (erasable programmable read only memory), an EEPROM (electrically erasable programmable read only memory), a RAM (random access memory), and a flash memory. All or a part of the memory may be provided in the processor.

The controller 120 may include an RRC processor 121 and an RLC processor 122. The RRC processor 121 performs processing in the processing of the RRC layer. The RRC processor 121 may be referred to as an RRC entity. The RLC processor 122 performs processing in the processing of the RLC layer which is a lower layer than the RRC layer. The RLC processor 122 may be referred to as an RLC entity. The RLC processor 122 may include, for example, a TM RLC entity that performs data transfer in a transparent mode (Transparent Mode: TM), a UM RLC entity that performs data transfer in an unacknowledged mode (Unacknowledged Mode: UM), and an AM RLC entity that performs data transfer in an acknowledged mode (Acknowledged Mode: AM). Note that the RRC processor 121 and the RLC processor 122 may be configured by one processor or may be configured by a plurality of processors.

In the UE 100 configured as described above, after transmitting the path information to the base station 200, the transmitter 111 transmits a message notifying the base station of the path information update. In a case where an acknowledgement based on the message has not been received from the base station even after a designated duration has elapsed since the message was transmitted to the base station, the controller 120 may perform retransmission control to transmit the message again. Further, after receiving the path information from the UE 100, a receiver 212 of the base station 200 receives a message notifying the base station 200 of the path information update from the UE 100. The receiver 212 receives the message by the UE 100 executing retransmission control of transmitting the message again in a case where the UE 100 has not received an acknowledgement based on the message from the base station 200 even after a designated duration has elapsed since the message was transmitted to the base station 200. As a result, the UE 100 can retransmit the message when there is a possibility that the base station 200 has not normally received the path information update notification message. As a result, it is possible to avoid a state in which the path information cannot be updated unintentionally for the network 10 and the UE 100. The UE 100 can perform the path information update notification at an appropriate timing even after performing path information update notification.

In addition, in the UE 100, the controller 120 can report a timestamp when timestamp report is configured. Therefore, when the timestamp report based on the path information is configured, it is determined whether or not to perform path information update notification to the base station 200 based on the time difference configured from the base station 200. In addition, the controller 120 performs the determination based on the distance difference before the determination based on the time difference. Therefore, even when the timestamp report is configured, the controller 120 determines whether or not to perform path information update notification based on the distance difference configured from the base station 200. As a result, when the timestamp report is configured, the UE 100 can flexibly determine whether or not to perform the path information update notification as compared with the case where only the determination based on the time difference can be made. As a result, the UE 100 can perform path information update notification at an appropriate timing. In addition, since the condition for performing path information update notification is clarified, the network 10 and the UE 100 can correctly cooperate with each other to update the path information.

### (Configuration of Base Station)

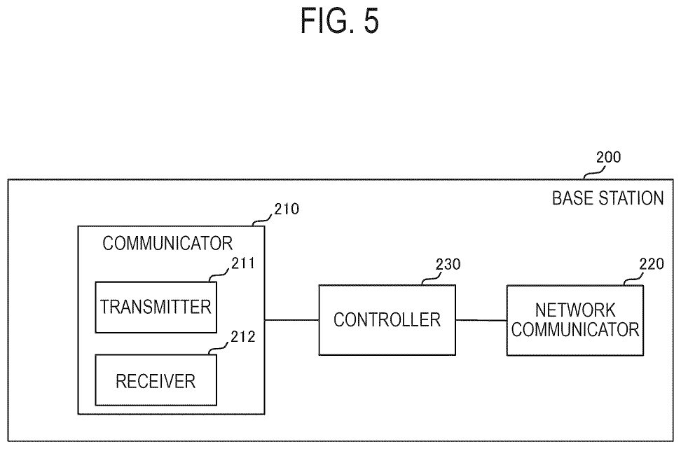

A configuration of the base station 200 according to the embodiment will be described with reference to FIG. 5. The base station 200 includes a communicator 210, a network communicator 220, and a controller 230.

For example, the communicator 210 receives a radio signal from the UE 100 and transmits a radio signal to the UE 100. The communicator 210 includes at least one transmitter 211 and at least one receiver 212. The transmitter 211 and the receiver 212 may include an RF circuit. The RF circuit performs analog processing of a signal transmitted and received via the antenna. The RF circuit may include a high frequency filter, an amplifier, a modulator, a low pass filter, and the like.

The network communicator 220 transmits and receives a signal to and from a network. The network communicator 220 receives a signal from a neighboring base station connected via the Xn interface that is an interface between base stations, for example, and transmits a signal to the neighboring base station. The network communicator 220 receives a signal from the core network apparatus 300 connected via the NG interface, for example, and transmits a signal to the core network apparatus 300.

The controller 230 performs various types of control in the base station 200. The controller 230 controls, for example, communication with the UE 100 via the communicator 210. The controller 230 controls, for example, communication with a node (for example, the neighboring base station or the core network apparatus 300) via the network communicator 220. The operation of the base station 200 described above and described below may be an operation controlled by the controller 230. The controller 230 may include at least one processor capable of executing a program and a memory that stores the program. The processor may perform the program and perform the operation of the controller 230. The controller 230 may include a digital signal processor that performs digital processing of a signal transmitted and received via the antenna and the RF circuit. The digital processing includes processing of the protocol stack of the RAN. Note that the memory stores the program to be performed by the processor, parameters related to the program, and data related to the program. All or a part of the memory may be provided in the processor.

In the base station 200 configured as described above, after receiving the path information from the UE 100, the receiver 212 receives a message notifying the base station 200 of the path information update from the UE 100. The receiver 212 receives the message by the UE 100 executing retransmission control of transmitting the message again in a case where the UE 100 has not received an acknowledgement based on the message from the base station 200 even after a designated duration has elapsed since the message was transmitted to the base station 200. As a result, the UE 100 can retransmit the message when there is a possibility that the base station 200 has not normally received the path information update notification message. As a result, it is possible to avoid a state in which the path information cannot be updated unintentionally for the network 10 and the UE 100. The UE 100 can perform the path information update notification at an appropriate timing even after performing path information update notification.

### (Operation Example)

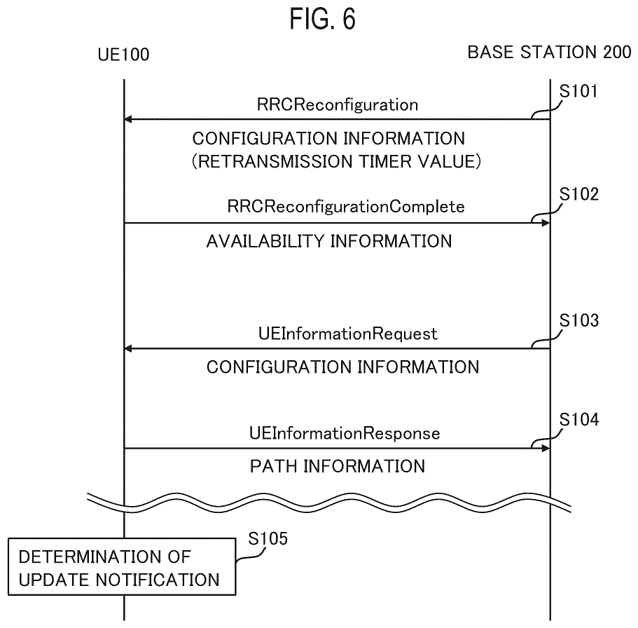

An operation example of the mobile communication system 1 will be described with reference to FIGS. 6 to 8. Note that hereinafter, the operation of the base station 200 may be the operation of the network 10.

### Step S101:

As illustrated in FIG. 6, the transmitter 211 of the base station 200 transmits, for example, a message including configuration information to the UE 100. The transmitter 211 may transmit, for example, an RRC reconfiguration (RRCReconfiguration) message to the UE 100 as the message including configuration information. Note that the message may be at least one of an RRC setup (RRCSetup) message, an RRC reestablishment (RRCReestablishment) message, and an RRC resume (RRCResume) message. Note that the message transmitted in S101 may be, for example, a message for causing the UE 100 to transmit a message including availability information to be described below.

The receiver 112 of the UE 100 receives the message from the base station 200. The receiver 112 may receive, for example, at least one of an RRC reconfiguration message, an RRC setup message, an RRC reestablishment message, and an RRC resume message.

The configuration information may include, for example, designated configuration information regarding update control for notifying the base station 200 of the path information update. The designated configuration information may include, for example, a threshold for determining whether or not to perform the path information update notification. The threshold may be information for triggering path information update notification. The threshold may be information for configuring a distance difference (for example, a spatial difference) and/or a time difference in the UE 100. The threshold may include a distance threshold for configuring the distance difference in the UE 100 and a time threshold for configuring the time difference in the UE 100.

The distance threshold may be used, for example, for comparison with a calculated distance difference calculated based on a new path of the UE 100. The new path may be a path different from a reported path. The new path is a path in which at least a part is changed from the reported path. The new path may be a path newly acquired by the UE 100 (the controller 120) after the report of the path information. The distance threshold may be used for comparison with a distance difference based on a point on a changed path. The distance threshold may be used, for example, for comparison with (a) a distance from a point on the reported path to a point on the changed path, (b) a distance from a destination of the reported path to a destination of the changed path, or (c) a distance from a measurement location (for example, a latest measurement location (current location)) of the UE 100 to a point closest to the measurement location among points on the path reported by the UE 100. Furthermore, the distance threshold may be used, for example, for comparison with the distance from the location of the UE 100 to a designated point in a case where the time measured by the UE 100 reaches a designated time (for example, the time of the timestamp) at the designated point on the path.

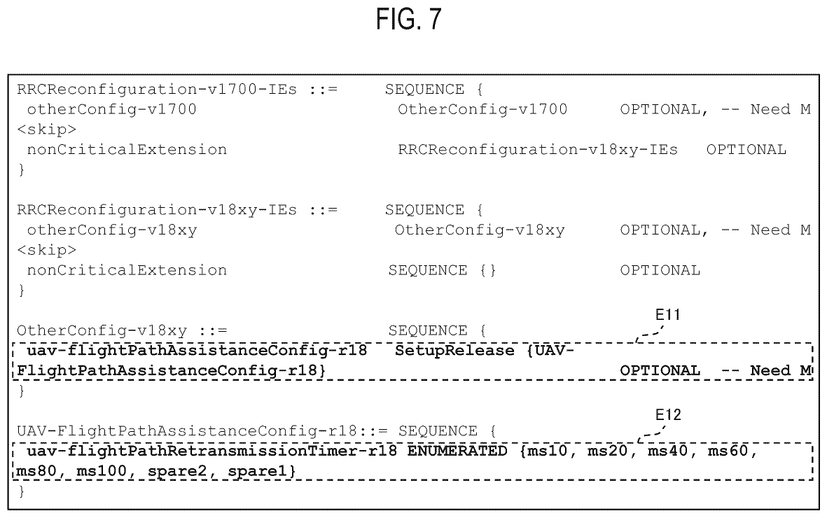

The time threshold may be used, for example, for comparison with a calculated time difference calculated based on a planned time of a new path of the UE 100. Furthermore, the time threshold may be used, for example, for comparison with a calculated time difference calculated based on a measurement time of the UE 100. The time threshold may be used, for example, for comparison between a planned arrival time at a point on the path reported by the UE 100 and a time at which the UE 100 arrives at the point. The time threshold may be used, for example, for comparison with (a) a time difference between a planned arrival time at each point on the reported path (that is, a time of a reported timestamp) and a planned arrival time at each point on the changed path, (b) a time difference between a planned arrival time at a destination of the reported path and a planned arrival time at a destination of the changed path, or (c) a time difference between a planned arrival time at a point on the path reported by the UE 100 (that is, the time of the reported timestamp) and a time at which the UE 100 arrives at the point. Note that as illustrated in E11 of FIG. 7, the configuration information (for example, OtherConfig) may include path configuration information (for example, UAV-FlightPathAssistanceConfig) regarding the configuration of the path information. The path configuration information may include designated configuration information or may be designated configuration information.

In addition, the configuration information may include a timer value (hereinafter, referred to as a retransmission timer value as appropriate) indicating a designated duration (hereinafter, referred to as a duration t as appropriate) to be described below. As illustrated in E12 of FIG. 7, the path configuration information may include a retransmission timer value (uav-flightPathRetransmissionTimer). As a result, the receiver 112 of the UE 100 can receive the retransmission timer value from the base station 200. The controller 120 of the base station 200 may include the retransmission timer value in the configuration information when permitting the notification of the path information update to the base station 200 using a message (for example, a UE assistance information message) that can be transmitted at an any time of the UE 100.

The configuration information (or designated configuration information) may include information (hereinafter, referred to as determination trigger information as appropriate) that triggers the determination as to whether or not to perform the path information update notification. The determination trigger information may be, for example, information for specifying an event for calculating a distance difference and/or a time difference. The controller 120 may initiate the determination based on an occurrence of the event. The event may occur, for example, by acquisition of location information (or location coordinates) of the (current) UE 100. The event may occur, for example, at a specific time such as a planned arrival time at each point on the planned path. In addition, the determination trigger information may include information specifying a determination cycle, a determination frequency, and/or a determination spacing.

For example, in a case where the path information is available in the UE 100, the controller 120 of the UE 100 may perform control of the following processing.

### Step S102:

The transmitter 111 of the UE 100 transmits a message including availability information to the base station 200. The receiver 212 of the base station 200 receives the message including the availability information from the UE 100. The message is, for example, an RRC reestablishment complete (RRC ReestablishmentComplete) message. In addition to the RRC reestablishment complete message, the message used to transmit the availability information may be, for example, at least one of an RRC setup complete (RRC SetupComplete) message, an RRC connection reestablishment complete (RRC ConnectionReestablishmentComplete) message, an RRC reconfiguration complete (RRCReconfigurationComplete) message, an RRC resume complete (RRCResumeComplete) message, and a UE assistance information (UE Assistance Information) message.

When receiving the availability information, the controller 230 of the base station 200 may perform control to perform the processing of step S103.

### Step S103:

The transmitter 211 of the base station 200 transmits a UE information request (UEInformationRequest) message including configuration information for requesting report of path information to the UE 100. The receiver 112 of the UE 100 receives the UE information request message including the configuration information from the base station 200. The message may be a message requesting the path information and/or the report of the path information. Note that the UE information request message is a message used by the network 10 to retrieve information from the UE 100.

The configuration information may be information (for example, FlightPathInfoReportConfig) for specifying (specify) the configuration of the report of the path information. Note that the configuration information may include, for example, information (for example, maxWayPointNumber) indicating a maximum number of points (for example, a waypoint (way point)) on the path that can be included in the report of the path information when the UE 100 can use the path information. The configuration information may include information (for example, includeTimeStamp) indicating whether or not a timestamp of each point can be reported in the report of the path information when the UE 100 can use the timestamp information. With the information, the UE 100 may be configured to report the timestamp. The configuration information may include information for requesting (instructing) the report of the timestamp. The controller 120 of the UE 100 may perform control to perform the processing of step S104 based on the configuration information.

Note that the configuration information for requesting the report of the path information may include the above-described designated configuration information regarding update control for notifying the base station 200 of the path information update. The configuration information or the designated configuration information may include a retransmission timer value. Further, the configuration information or the designated configuration information may include determination trigger information.

### Step S104:

The transmitter 111 of the UE 100 transmits a UE information response message including path information regarding a planned path of the UE 100 to the base station 200. As a result, the transmitter 111 transmits the path information to the UE 100. The receiver 212 of the base station 200 receives the UE information response message including the path information from the UE 100. Note that the UE information response message is a message used to transfer (transfer) information requested by the network 10.

The path information may include, for example, the information regarding the planned path of the UE 100. The path information may indicate, for example, a planned flight path as the planned path of the UE 100. The path information may be referred to as, for example, “flightPathInfoReport”, “flightPath”, or the like. In addition, the path information may indicate a planned traveling path in a case where the UE 100 travels on a land path, or may indicate a planned sailing path in a case where the UE 100 sails on a sea path.

The path information may include location information including location coordinates (for example, location coordinates) of the UE 100. The location coordinates may represent a planned point (location). The location information may be waypoint location information (for example, wayPointLocation) that includes UE location coordinates for aerial (Aerial) UE operations. The waypoint location information may be an information element (LocationInfo) used to transfer detailed location information available by the UE 100 in order to correlate the measurement value with the position information of the UE. The location information may include (a list of) a plurality of pieces of waypoint location information. The waypoint may represent planned locations (planned locations) for the UE.

The location coordinates may correspond to each point on the path. Therefore, the planned path may be configured by a plurality of location coordinates. The path information may include information indicating location coordinates indicating a destination. The information indicating the location coordinates indicating the destination may be location coordinates mapped to a specific location (for example, a first or last of (a list of) a plurality of pieces of waypoint location information). The information indicating the location coordinates indicating the destination may be associated with the information indicating the destination.

The path information may include timestamp information (for example, timeStamp). The timestamp information may include information indicating a timestamp of a waypoint representing a planned location of the UE. The information may be, for example, information (for example, AbsoluteTimeInfo) indicating an absolute time in a “YY-MM-DD HH:MM:SS” format and using BCD (Binary-coded decimal) encoding.

For example, the controller 120 of the UE 100 may acquire the path information from an air traffic control system. The controller 120 may receive a GNSS (global navigation satellite system) signal and/or a GPS (global positioning system) signal for detecting a location, a speed, an altitude, and the like, and acquire (generate) path information. The controller 120 may acquire (generate) the path information by detecting the location, the speed, the altitude, and the like by a sensor included in the UE 100.

Note that the path information may include information indicating the altitude and/or information indicating the speed of the UE 100. Note that the UE 100 may include a sensor for detecting the altitude and/or the speed of the UE 100.

Note that the controller 120 of the UE 100 may acquire path information regarding a new planned path after reporting the path information. For example, the controller 120 may acquire the path information regarding the new planned path according to a user's input, a movement status of the UE 100, and the like.

### Step S105:

The controller 120 of the UE 100 determines whether or not to perform the path information update notification. The controller 120 may initiate the determination based on the configuration information. For example, the controller 120 may initiate the determination based on the determination trigger information. Details of the determination will be described below.

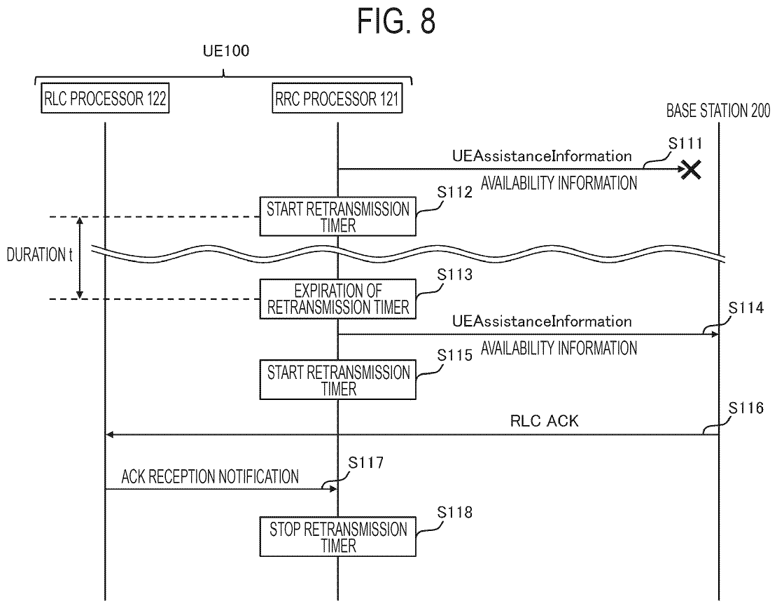

In a case where it is determined to perform the path information update notification, the controller 120 may perform the processing of step S111 of FIG. 8. Therefore, the controller 120 may perform update control for performing the path information update notification. When it is determined not to perform the path information update notification, the controller 120 may perform control so as not to perform the processing of step S111 of FIG. 8.

### Step S111:

As illustrated in FIG. 8, the transmitter 111 of the UE 100 transmits the availability information to the base station 200. The transmitter 111 transmits, for example, a UE assistance information message including the availability information to the base station 200. Therefore, the controller 120 of the UE 100 may include the availability information in the UE assistance information message. The controller 120 of the UE 100 may control to transmit the availability information to the base station 200.

The RRC processor 121 of the controller 120 may generate an RRC message as a message notifying the base station 200 of the path information update. The RRC processor 121 may include the availability information in the RRC message. The RRC processor 121 may control the transmitter 111 to transmit the RRC message. As a result, the transmitter 111 transmits the RRC message in order to perform the path information update notification in the RRC layer. After transmitting the path information to the base station 200, the transmitter 111 can transmit the RRC message as the message notifying the base station of the path information update.

The RRC message may be, for example, a message that can be transmitted at an any time of the UE 100. The message may be a message transmitted with the UE 100 as the origin such as a UE assistance information message used for indication of the UE assistance information to the network. Alternatively, the RRC message may be a message (for example, an RRC reconfiguration complete message, an RRC setup complete message, an RRC reestablishment complete message, and an RRC resume complete message) transmitted as a response to the RRC message (for example, an RRC reconfiguration message, an RRC setup message, an RRC reestablishment message, and an RRC resume message) from the base station 200.

The transmitter 111 may transmit a UE origin message as the path information update notification message when the base station 200 permits the path information update notification using the message (hereinafter, referred to as a UE origin message) that can be transmitted at an any time of the UE 100. On the other hand, when the base station 200 does not permit the path information update notification using the UE origin message, the transmitter 111 may stop the transmission itself of the path information update notification message. Alternatively, the transmitter 111 may transmit a message transmitted as a response to the RRC message from the base station 200 as the path information update notification message.

For example, when the retransmission timer value is included in the configuration information, the controller 120 may determine that the path information update notification using the UE origin message has been permitted. Therefore, when the retransmission timer value is received, the controller 120 may consider that the UE origin message has been permitted to be transmitted as the path information update notification message. On the other hand, when the retransmission timer value is not included in the configuration information, the controller 120 may determine that the path information update notification using the UE origin message has not been permitted.

Note that the availability information transmitted after reporting the path information may be treated as the path information update notification. The availability information may be information indicating that either new path information is available or updated path information is available. In this case, the availability information in step S111 may indicate that the updated path information is available. The availability information in step S102 may indicate that the new path information is available.

Note that the RRC processor 121 may, for example, trigger, request, configure, or instruct (indicate) the lower layer to transmit a path information update notification message in an RLC packet (for example, an AMD (AM data) PDU (protocol data unit)) including a field for requesting an acknowledgement or a negative acknowledgement. As a result, the RLC processor 122 may generate, for example, an RLC packet including a P field indicating whether or not the transmitting side of the AM RLC entity requests state (STATUS) report from the peer AM RLC entity, as the field for requesting the acknowledgement or the negative acknowledgement. The RLC processor 122 may set a value indicating that the state report is requested in the field.

Further, the RLC processor 122 may generate two identical copies of the RLC packet corresponding to the path information update notification message. The RLC processor 122 may transmit one RLC packet to the lower layer and transmit the other RLC packet to a retransmission buffer for message transmission.

In the present operation example, it is assumed that the receiver 212 of the base station 200 cannot receive (the message including) the availability information from the UE 100. When receiving the availability information from the UE 100, the receiver 212 of the base station 200 may perform the processing in and after step S114.

Note that hereinafter, the controller 120 that performs processing in the RRC layer is appropriately referred to as an RRC processor 121. Furthermore, the controller 120 that performs processing in the RLC layer is appropriately referred to as an RLC processor 122.

### Step S112:

The RRC processor 121 initiates a timer (hereinafter, referred to as a retransmission timer as appropriate) based on the transmission of the message notifying the base station 200 of the path information update. The RRC processor 121 may initiate the retransmission timer based on the transmission of the message including the availability information (after transmitting reported path information).

In addition, the RRC processor 121 initiates a retransmission timer in which a retransmission timer value is set. When the retransmission timer value is received from the base station 200, the RRC processor 121 may set the retransmission timer value in the retransmission timer. When the retransmission timer value is defined in advance in the specification, the RRC processor 121 may set the defined value as the retransmission timer value in the retransmission timer.

### Step S113:

When a duration t elapses, the retransmission timer expires. In a case where an acknowledgement based on the message has not been received from the base station 200 even after the duration t has elapsed since the message was transmitted in step S112, the RRC processor 121 can perform retransmission control. The controller 120 can grasp that the duration t has elapsed since the message was transmitted, based on the expiration of the retransmission timer. The controller 120 may consider that the base station 200 has failed to normally receive the message due to the elapse of the duration t. The controller 120 may perform retransmission control in a case where it is determined that the base station 200 has not normally received the message. Therefore, the RRC processor 121 may perform the retransmission control based on the expiration of the retransmission timer. Specifically, the RRC processor 121 can perform the following processing.

### Step S114:

The RRC processor 121 performs the retransmission control of transmitting the path information update notification message again. Specifically, the RRC processor 121 controls the transmitter 111 to transmit the UE assistance information message including the availability information again. As a result, the transmitter 111 retransmits the UE assistance information message to the base station 200.

In the present operation example, the receiver 212 of the base station 200 receives the message including the availability information from the UE 100. The controller 230 of the base station 200 performs control to perform the processing of step S116 based on the reception of the message.

### Step S115:

The RRC processor 121 initiates the retransmission timer as in step S112.

### Step S116:

The transmitter 211 of the base station 200 transmits an acknowledgement to the UE 100 based on the reception of the message. In the present operation example, the transmitter 211 transmits an acknowledgement (specifically, RCL ACK (Acknowledgment)) to the UE 100 in the RLC layer.

The RLC processor of the controller 230 may generate, for example, an acknowledgement packet. The packet may be, for example, a packet (for example, STATUS PDU) including an acknowledgement SN (ACK_SN) field. The acknowledgement field may indicate a sequence number (SN) of the next unreceived RLC SDU which is RLC SDU (Service Data Unit) that is not reported as missing in the packet (STATUS PDU). The RLC processor may include a field (NACK_SN) indicating a sequence number of the RLC SDU (or the RLC SDU segment) detected as a loss on the reception side of the AM RLC entity in the packet.

The receiver 112 of the UE 100 receives the acknowledgement from the base station 200. In the present operation example, the receiver 112 receives the acknowledgement from the base station 200 in the RLC layer, that is, in a layer lower than the RRC layer. The RLC processor 122 of the controller 230 may perform the processing of step S117 based on the reception of the acknowledgement.

For example, when receiving the packet including the ACK_SN field, the RLC processor 122 may interpret that all the RLC SDUs up to the RLC SDU with the sequence number of the ACK_SN field have been received by the peer AM RLC entity (that is, the base station 200) except for the RLC SDU with the sequence number indicated by NACK_SN. When the RLC processor 122 interprets that the RLC SDU of the sequence number of the packet corresponding to the path information update notification message has been received by the base station 200, the RLC processor may perform the processing of step S117. Further, the RLC processor 122 may discard the RLC packet in the retransmission buffer based on the interpretation.

Note that the RLC processor 122 may perform control to retransmit the RLC packet in the retransmission buffer when receiving a negative acknowledgement or when there is no response from the base station 200 for a certain duration shorter than the duration t. The RRC processor of the base station 200 and the RLC processor 122 of the UE 100 may perform, for example, an automatic repeat request (Automatic Repeat request: ARQ) procedure.

### Step S117:

The RLC processor 122 indicates, to the upper layer, reception of the acknowledgment to the path information update notification message (hereinafter, referred to as an ACK reception notification as appropriate). For example, the RLC processor 122 may provide information indicating that an acknowledgement has been received to the upper layer as the ACK reception notification. The RLC processor 122 may provide, as the ACK reception notification, an acknowledgement to the path information update notification message to the upper layer. As a result, the RRC processor 121 receives the ACK reception notification from the lower layer. For example, the RRC processor 121 may receive the ACK reception notification from the RLC processor 122 via a PDCP processor (PDCP entity) included in the controller 120. As a result, the RRC processor 121 can grasp that the path information update notification message has been received by the base station 200.

### Step S118:

The RRC processor 121 stops the retransmission timer based on the reception of the acknowledgement based on the path information update notification message from the base station 200. As a result, since the retransmission timer does not expire, when the acknowledgment is received from the base station 200, even if a request for reporting the path information (for example, a message including information for specifying the configuration of the report of the path information) is not received from the base station 200 after the transmission of the message, the RRC processor 121 (that is, the controller 120) can cancel the retransmission control.

Thereafter, based on the availability information, the base station 200 may not perform the processing of step S103 or may not perform the processing of step S103. The controller 120 of the UE 100 may perform control so as not to perform the retransmission control even if the processing of step S103 is not performed.

As described above, after transmitting the path information to the base station 200, the transmitter 111 of the UE 100 transmits the message notifying the base station of the path information update. In a case where an acknowledgement based on the message has not been received from the base station even after a designated duration has elapsed since the message was transmitted to the base station, the controller 120 may perform retransmission control to transmit the message again. Further, after receiving the path information from the UE 100, a receiver 212 of the base station 200 receives a message notifying the base station 200 of the path information update from the UE 100. The receiver 212 receives the message by the UE 100 executing retransmission control of transmitting the message again in a case where the UE 100 has not received an acknowledgement based on the message from the base station 200 even after a designated duration has elapsed since the message was transmitted to the base station 200. As a result, the UE 100 can retransmit the message when there is a possibility that the base station 200 has not normally received the path information update notification message. As a result, it is possible to avoid a state in which the path information cannot be updated unintentionally for the network 10 and the UE 100. The UE 100 can perform the path information update notification at an appropriate timing even after performing path information update notification.

The transmitter 111 may transmit the RRC message as the message in order to perform the path information update notification in the RRC layer. The receiver 112 may receive the acknowledgement from the base station 200 in the layer lower than the RRC layer, so that the UE 100 can grasp that the base station 200 has received the RRC message based on the reception of the acknowledgement even when the response message to the message notifying of the path information update has not been defined in the RRC layer.

When receiving the acknowledgement, the controller 120 may stop the retransmission control even if the request for reporting the path information is not received from the base station 200 after the transmission of the message.

Further, the receiver 112 may receive a retransmission timer value indicating a designated duration from the base station 200. The controller 120 may initiate a retransmission timer in which a retransmission timer value is set based on the transmission of the message. The retransmission control may be performed based on the expiration of the retransmission timer value. As a result, since the network 10 can control the retransmission timer value, retransmission of the message can be controlled.

Further, when the retransmission timer value is received, the controller 120 may consider that the UE 100 has been permitted to transmit, as the message, a message that can be transmitted at an any time. As a result, the base station 200 can notify the UE 100 that the base station permits the path information update notification using the UE origin message by transmitting the retransmission timer value. The network 10 can omit transmission of other information indicating the permission, and can save radio resources.

### (First Operation Example Regarding Determination of Update Notification)

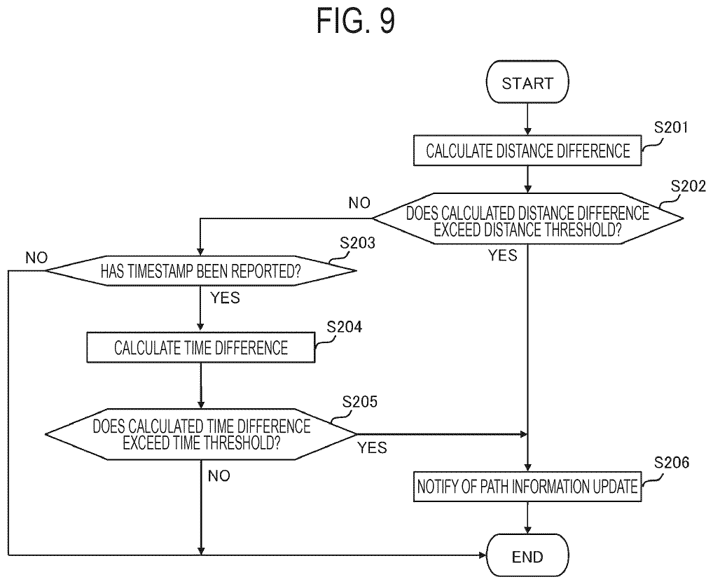

Next, a first operation example regarding determination of update notification will be described with reference to FIG. 9. The description of parts similar to those in the above-described operation example will be omitted. For example, the controller 120 of the UE 100 may perform the present operation example in step S105 described above. For example, the controller 120 may initiate the following processing based on configuration information (for example, the determination trigger information). Note that the receiver 112 of the UE 100 may receive at least one of a distance threshold for configuring a distance difference and a time threshold for configuring a time difference from the base station 200. The controller 120 of the UE 100 may acquire path information regarding a new path.

### Step S201:

The controller 120 calculates a distance difference. For example, the controller 120 may calculate a distance difference based on a new path of the UE 100.

The controller 120 may calculate a difference between a designated point (for example, a point closest to a current location of the UE 100) on the new path and at least one or more points on the reported path as the distance difference. Furthermore, the controller 120 may calculate a difference between each point on the new path and each point on the reported path as the distance difference. Furthermore, the controller 120 may calculate a difference between a destination of the new path and a destination of the reported path as the distance difference.

Note that the controller 120 may calculate a distance difference between a location of the UE 100 and a point on the path. The controller 120 may calculate a distance from the location of the UE 100 in a case where a time measured by the UE 100 reaches a designated time (for example, the time of the timestamp) at a designated point on the path to the designated point on the path. Furthermore, the controller 120 may calculate, for example, a distance from a measurement location (for example, a current location) of the UE 100 to a point closest to the measurement location among points on the path reported by the UE 100.

The controller 120 may calculate a two-dimensional distance difference, or may calculate a three-dimensional distance difference, that is, a spatial difference, as the distance difference. Note that in a case where the controller 120 has calculated the distance difference before the determination of the update notification, the step may be omitted.

### Step S202:

The controller 120 determines whether or not a calculated distance difference exceeds a distance threshold. In a case where the calculated distance difference exceeds the distance threshold, the controller 120 performs the processing of step S206. On the other hand, in a case where the calculated distance difference does not exceed the distance threshold, the controller 120 performs the processing of step S203. Note that the distance threshold may be configured by a single parameter (for example, a designated threshold) or may be configured by a plurality of parameters (for example, a designated threshold, an offset value, or the like). In a case where a plurality of calculated distance differences have been calculated, the controller 120 may perform the processing of step S206 in a case where at least a certain number or more (or all) of the plurality of calculated distance differences exceed the distance threshold. On the other hand, when at least a certain number or more (or all) of the plurality of calculated distance differences do not exceed the distance threshold, the controller 120 may perform the processing of step S203.

Note that in a case where the calculated distance difference based on the location of the UE 100 exceeds the distance threshold, the controller 120 may acquire path information indicating a new path.

### Step S203:

The controller 120 determines whether or not a timestamp has been reported. For example, in a case where a timestamp exists in the path information reported to the base station 200 (that is, a timestamp is included), the controller 120 may determine that the timestamp has been reported. On the other hand, for example, when a timestamp does not exist in the path information reported to the base station 200 (that is, a timestamp is not included), the controller 120 may determine that the timestamp has not been reported.

In a case where the timestamp has been reported (it is determined that the timestamp has been reported), the controller 120 performs the processing of step S204. On the other hand, in a case where the timestamp has not been reported (it is determined that the timestamp has not been reported), the controller 120 may end the processing. In this case, the UE 100 may not perform the processing of step S111.

Alternatively, for example, the controller 120 may determine at least one of (a) whether or not a timestamp report is configured, (b) whether or not a timestamp report is requested (instructed), and (c) whether or not assignment of a timestamp is instructed to each waypoint. For example, in a case where (a) a timestamp report is configured, (b) a timestamp report is requested (instructed), or (c) assignment of a timestamp is instructed to each waypoint, the controller 120 may perform the processing of step S204. Otherwise, the controller 120 may end the processing.

### Step S204:

The controller 120 calculates a time difference. For example, the controller 120 may calculate a time difference based on a planned time of a new path of the UE 100. For example, the controller 120 may calculate a time difference based on a planned arrival time at a point on a changed path and a configured time difference (for example, a time threshold). For example, the controller 120 may calculate a time difference based on a planned arrival time at a destination of a reported path and a planned arrival time at a destination of the changed path. For example, the controller 120 may calculate a time difference from an arrival time at a point on the path and a timestamp at the point.

Note that in a case where the time difference has been calculated before the determination of the update notification, the controller 120 may omit the step.

### Step S205:

The controller 120 determines whether or not a calculated time difference exceeds a time threshold. In a case where the calculated time difference exceeds the time threshold, the controller 120 performs the processing of step S206. On the other hand, in a case where the calculated time difference does not exceed the time threshold, the controller 120 ends the processing. Note that the time threshold may be configured by a single parameter (for example, a designated threshold) or may be configured by a plurality of parameters (for example, a designated threshold, an offset value, or the like).

### Step S206:

The controller 120 determines to perform the path information update notification. For example, the controller 120 may perform the processing of step S111.

The controller 120 determines whether or not to perform the path information update notification based on the distance difference configured from the base station 200 by the processing of step S202. In addition, the controller 120 determines whether or not to perform the path information update notification based on the time difference configured from the base station 200 by the processing of step S205.

As described above, the controller 120 can report a timestamp when timestamp report is configured. Therefore, when the timestamp report based on the path information is configured, it is determined whether or not to perform path information update notification to the base station 200 based on the time difference configured from the base station 200. In addition, the controller 120 performs the determination based on the distance difference before the determination based on the time difference. Therefore, even when the timestamp report is configured, the controller 120 determines whether or not to perform path information update notification based on the distance difference configured from the base station 200. As a result, when the timestamp report is configured, the UE 100 can flexibly determine whether or not to perform the path information update notification as compared with the case where only the determination based on the time difference can be made. As a result, the UE 100 can perform path information update notification at an appropriate timing. In addition, since the condition for performing path information update notification is clarified, the network 10 and the UE 100 can correctly cooperate with each other to update the path information.

Furthermore, the receiver 112 may receive at least one of the distance threshold for configuring the distance difference and the time threshold for configuring the time difference from the base station. As indicated in steps S202, S205, and S206, when the calculated distance difference calculated based on the new path of the UE 100 exceeds the distance threshold or when the calculated time difference calculated based on the planned time of the new path of the UE 100 exceeds the time threshold, the controller 120 may determine to perform the path information update notification. As a result, for example, when the timestamp report is configured, the UE 100 can perform the path information update notification when the calculated distance difference exceeds the distance threshold even when the calculated time difference does not exceed the time threshold. Since the number of opportunities for performing the path information update notification increases, communication control can be performed based on appropriate path information.

In addition, as indicated in steps S202 and S206, when the calculated distance difference exceeds the distance threshold, the controller 120 may determine to perform the path information update notification without performing the determination based on the time difference configured from the base station 200. Therefore, regardless of whether or not the timestamp report is configured, the controller 120 may prioritize the determination based on the distance difference over the determination based on the time difference. As a result, since the UE 100 can omit the determination processing based on the time difference, the number of determination processes can be reduced. As a result, the power consumption of the UE 100 can be suppressed.

### (Second Operation Example Regarding Determination of Update Notification)

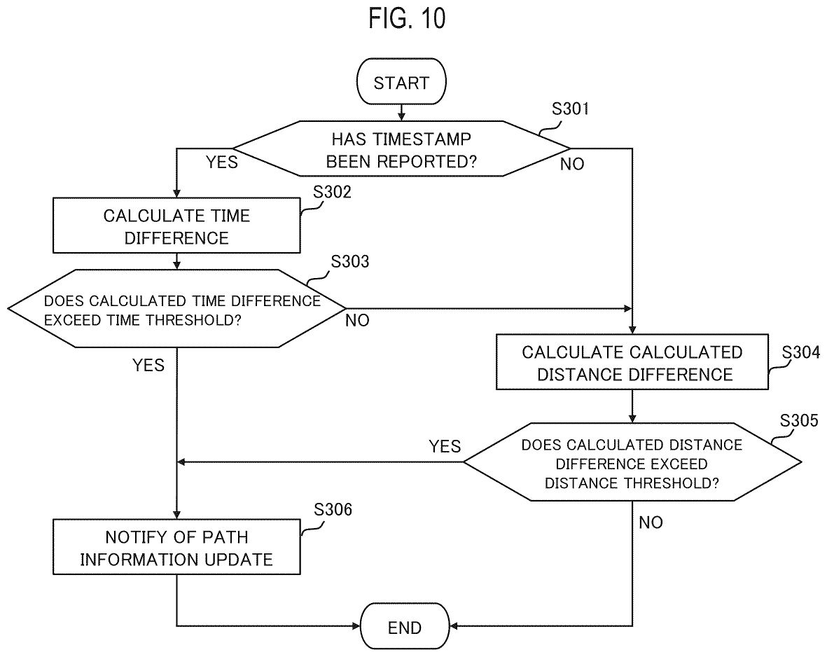

Next, a second operation example regarding determination of an update notification will be described with reference to FIG. 10. The description of parts similar to those in the above-described operation example will be omitted.

### Step 301:

The controller 120 performs processing similar to that in step S203. For example, the controller 120 may perform the processing of step S302 in (a) a case where a timestamp report is configured, (b) a case where a timestamp report is requested (instructed), (c) a case where assignment of a timestamp is instructed to each waypoint, or (d) a case where a timestamp exists in the path information reported to the base station 200 (that is, a timestamp is included). Otherwise, the controller 120 may perform the processing of step S304.

### Step S302:

The controller 120 calculates a time difference. The controller 120 may perform processing similar to that in step S204.

### Step S303:

The controller 120 performs processing similar to that in step S205. In a case where the calculated time difference exceeds the time threshold, the controller 120 performs the processing of step S306. On the other hand, in a case where the calculated time difference does not exceed the time threshold, the controller 120 performs the processing of step S304.

### Step S304:

The controller 120 calculates a distance difference. The controller 120 may perform processing similar to that in step S201.

### Step S305:

The controller 120 performs processing similar to that in step S202. In a case where the calculated distance difference exceeds the distance threshold, the controller 120 performs the processing of step S206. On the other hand, in a case where the calculated distance difference does not exceed the distance threshold, the controller 120 ends the processing.

### Step S306:

The controller 120 determines to perform the path information update notification. The controller 120 may perform processing similar to that in step S206.

As described above, as indicated in steps S303 and S306, when the calculated time difference exceeds the time threshold, the controller 120 may determine to perform the path information update notification without performing the determination based on the distance difference configured from the base station 200. That is, the controller 120 may prioritize the determination based on the time difference over the determination based on the distance difference. As a result, since the UE 100 can omit the determination processing based on the distance difference, the number of determination processes can be reduced. As a result, the power consumption of the UE 100 can be suppressed.

### (Third Operation Example Regarding Determination of Update Notification)

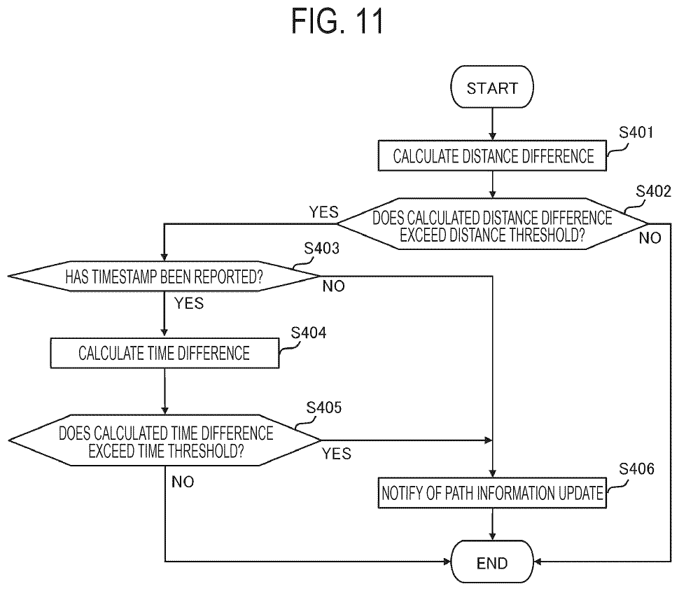

Next, a second operation example regarding determination of update notification will be described with reference to FIG. 11. The description of parts similar to those in the above-described operation example will be omitted.

### Step S401:

The controller 120 calculates a distance difference. The controller 120 may perform processing similar to that in step S201.

### Step S402:

The controller 120 performs processing similar to that in step S202. In a case where the calculated distance difference exceeds the distance threshold, the controller 120 performs the processing of step S403. On the other hand, in a case where the calculated distance difference does not exceed the distance threshold, the controller 120 ends the processing.

### Step S403:

The controller 120 performs processing similar to that in step S203. For example, the controller 120 may perform the processing of step S404 in (a) a case where a timestamp report is configured, (b) a case where a timestamp report is requested (instructed), (c) a case where assignment of a timestamp is instructed to each waypoint, or (d) a case where a timestamp exists in the path information reported to the base station 200 (that is, a timestamp is included). Otherwise, the controller 120 may perform the processing of step S406.

### Step S404:

The controller 120 calculates a time difference. The controller 120 may perform processing similar to that in step S204.

### Step S405:

The controller 120 performs processing similar to that in step S205. In a case where the calculated time difference exceeds the time threshold, the controller 120 performs the processing of step S406. On the other hand, in a case where the calculated time difference does not exceed the time threshold, the controller 120 ends the processing.

### Step S406:

The controller 120 determines to perform the path information update notification. The controller 120 may perform processing similar to that in step S206.

As described above, the receiver 112 may receive the distance threshold for configuring the distance difference and the time threshold for configuring the time difference from the base station. As indicated in steps S402, S405, and S406, when the calculated distance difference calculated based on the new path of the UE 100 exceeds the distance threshold and the calculated time difference calculated based on the planned time of the new path of the UE 100 exceeds the time threshold, the controller 120 may determine to perform the path information update notification. As a result, since the UE 100 determines whether or not to perform the path information update notification in both the determination based on the time difference and the determination based on the distance difference, it is possible to avoid frequently performing the path information update notification. As a result, it is possible to suppress consumption of a large number of radio resources based on the path information update notification.

Furthermore, in a case where the calculated distance difference does not exceed the distance threshold, the controller 120 may determine not to perform the path information update notification without performing the determination based on the time difference configured from the base station 200. As a result, since the UE 100 can omit the determination processing based on the time difference, the number of determination processes can be reduced. As a result, the power consumption of the UE 100 can be suppressed.

Furthermore, as indicated in steps S403 and S406, in a case where the timestamp report has not been performed, the controller 120 may perform the determination based on the distance difference configured from the base station 200 without performing the determination based on the time difference configured from the base station 200. That is, the controller 120 may determine to perform the path information update notification only by the determination based on the time difference. As a result, the UE 100 can perform the path information update notification even when the timestamp report is not configured.

Note that since the UE 100 performs the processing of step S404 after the processing of step S403, the processing of steps S404 and S405 can be omitted in a case where timestamp report is not configured. The number of processes of the UE 100 can be reduced, and the power consumption of the UE 100 can be suppressed.

### (Other Embodiments)

In the above-described embodiment, a case where the UE 100 receives a reception response from the base station 200 in the RLC layer has been described as an example, but the present disclosure is not limited thereto. For example, the UE 100 may receive a reception response from the base station 200 in the MAC layer. The UE 100 may stop the retransmission control based on the reception response in the MAC layer.

In the above-described embodiment, the UE 100 may receive a timer value of a prohibit timer regarding the transmission of the availability information from the base station 200. The controller 120 may set the timer value in the prohibit timer. The controller 120 of the UE 100 may initiate the prohibit timer (in which the timer value is set) based on the transmission of the message including the availability information. In a case where the prohibit timer is in operation, the controller 120 may prohibit the transmission of the message including the availability information. In a case where the prohibit timer expires or is stopped, the controller 120 may transmit the message including the availability information.

Here, even when the prohibit timer is in operation, the controller 120 may control the transmitter 111 to transmit the message including the availability information, based on the expiration of the retransmission timer. Alternatively, the controller 120 may stop the prohibit timer, based on the expiration of the retransmission timer. The controller 120 may control the transmitter 111 to transmit the message including the availability information after the prohibit timer is stopped. The controller 120 may restart the prohibit timer based on the transmission of the message including the availability information. The controller 120 may reset the timer value and initiate the prohibit timer.

In the above-described embodiment, in the third operation example related to the determination of the update notification, the determination based on the distance difference is performed first, and the determination based on the time difference is performed later, but the present disclosure is not limited thereto. The determination based on the time difference may be performed first, and the determination based on the distance difference may be performed later.

In the above-described embodiment, the UE 100 may determine which determination based on the distance difference and the determination based on the time difference is to be prioritized. The UE 100 may determine which determination is to be prioritized, for example, depending on implementation. The UE 100 may receive information specifying which determination is to be prioritized from the base station 200. The UE 100 may determine which determination is to be prioritized based on the information.

Note that in the above-described embodiment, the UE 100 may determine the update notification by another method different from the above-described method. In addition, the case where the UE 100 performs the retransmission control of the message has been described as an example, but the present disclosure is not limited thereto. The UE 100 does not need to perform retransmission control.

In the above-described embodiment, the mobile communication system based on the NR is described as the example of the mobile communication system 1. However, the mobile communication system 1 is not limited to the example. The mobile communication system 1 may be a system conforming to a TS of LTE (Long Term Evolution) or another generation system (for example, sixth generation) of the 3GPP standard. The base station 200 may be an eNB that provides E-UTRA user plane and control plane protocol terminations toward the UE 100 in LTE. The mobile communication system 1 may be a system conforming to a TS defined in a standard other than the 3GPP standard. The base station 200 may be an IAB (Integrated Access and Backhaul) donor or an IAB node.

In the above-described embodiment, the mobile communication system based on the NR is described as the example of the mobile communication system 1. However, the mobile communication system 1 is not limited to the example. The mobile communication system 1 may be a system conforming to a TS of LTE or another generation system (for example, sixth generation) of the 3GPP standard. The base station 200 may be an eNB that provides E-UTRA user plane and control plane protocol terminations toward the UE 100 in LTE. The mobile communication system 1 may be a system conforming to a TS defined in a standard other than the 3GPP standard.

The steps in the operation of the above-described embodiment are not necessarily performed in the chronological order according to the order described in the flowchart or the sequence diagram. For example, the steps in the operation may be performed in an order different from the order described in the flowchart or the sequence diagram or may be performed in parallel. A part of the steps in the operation may be removed, or additional steps may be added to the processing. Each operation flow described above is not necessarily implemented separately and independently, and two or more operation flows can be implemented in combination. For example, a part of steps of one operation flow may be added to another operation flow, or a part of steps of one operation flow may be replaced with a part of steps of another operation flow.

A program for causing a computer to execute each of the processes performed by the UE 100 or the base station 200 may be provided. The program may be recorded in a computer-readable medium. The program can be installed in the computer using the computer-readable medium. Here, the computer-readable medium in which the program is recorded may be a non-transitory recording medium. The non-transitory recording medium is not particularly limited, and may be, for example, a recording medium such as a CD-ROM (compact disk read only memory) or a DVD-ROM (digital versatile disc read only memory). A circuit that executes each of the processes performed by the UE 100 or the base station 200 may be integrated, and at least a part of the UE 100 or the base station 200 may be configured as a semiconductor integrated circuit (a chipset or a SoC (system on chip)).

In the above-described embodiment, the term “transmit” may mean performing processing of at least one layer in the protocol stack used for transmission or may mean physically transmitting a signal in a wireless or wired manner. Alternatively, the term “transmit” may mean a combination of performing the processing of at least one layer and physically transmitting the signal in a wireless or wired manner as described above. Similarly, the term “receive” may mean performing processing of at least one layer in a protocol stack used for reception or may mean physically receiving a signal in a wireless or wired manner. Alternatively, the term “receive” may mean a combination of performing the processing of at least one layer and physically receiving the signal in a wireless or wired manner as described above. Similarly, the term “obtain/acquire” may mean obtaining/acquiring information from stored information, may mean obtaining/acquiring information from information received from another node, or may mean obtaining/acquiring information by generating information. Similarly, the terms “based on” and “depending on/in response to” do not mean “based only on” or “depending only on/in response only to” unless explicitly stated otherwise. The term “based on” means both “based only on” and “at least partially based on”. Similarly, the term “depending on/in response to” means both “depending only on/in response only to” and “at least partially depending on/at least partially in response to”. Similarly, the terms “include” and “comprise” do not mean including only enumerated items, but mean both of including only enumerated items and including more items in addition to the enumerated items. Similarly, in the present disclosure, the term “or” does not mean exclusive OR, and means OR. Any reference to elements using designations such as “first”, “second”, and the like used in the present disclosure does not generally limit the amount or the order of the elements. Such designations may be used in the present disclosure as a convenient method to distinguish between two or more elements. References to first and second elements do not mean that only two elements can be employed therein or that the first element should precede the second element in any form. In the present disclosure, when articles such as “a”, “an”, and “the” in English are added by translation, such articles cover the plural meaning unless the context clearly indicates otherwise.

Although the present disclosure has been described according to examples, it is understood that the present disclosure is not limited to the examples or structures. The present disclosure also includes various modified examples or modifications made within an equivalent range. Various combinations or modes, or other combinations or modes including only one element, more elements, or less elements also fall within the scope and spirit of the present disclosure.

### SUPPLEMENTARY NOTES

Features related to the above-described embodiments are additionally described.

### Supplementary Note 1

A communication apparatus, including:
a receiver configured to receive a radio resource control (RRC) reconfiguration message including information for configuring a distance threshold for triggering path information update notification based on a distance and a time threshold for triggering the path information update notification based on a time, from a base station; and
a transmitter configured to transmit an RRC reconfiguration complete message including information indicating that the path information is available to the base station in response to reception of the RRC reconfiguration message, in which
the receiver receives a UE information request message including configuration information regarding report of the path information, from the base station,
the transmitter transmits a UE information response message including the path information to the base station in response to reception of the UE information request message, and
the transmitter transmits a UE assistance information message including the information indicating that the path information is available to the base station based on determination based on the distance threshold regardless of configuration of the time threshold.

### Supplementary Note 2

The communication apparatus according to supplementary note 1, in which
when a three-dimensional distance between location information of the transmitted path information and latest location information held by the communication apparatus exceeds the distance threshold, the transmitter transmits the UE assistance information message including the information indicating that the path information is available to the base station.

### Supplementary Note 3

The communication apparatus according to supplementary note 1 or 2, in which
even when not transmitting the UE assistance information message including the information indicating that the path information is available by the determination based on the distance threshold, the transmitter transmits the UE assistance information message including the information indicating that the path information is available to the base station based on determination based on the time threshold.

### Supplementary Note 4

A base station, including:
a transmitter configured to transmit a radio resource control (RRC) reconfiguration message including information for configuring a distance threshold for triggering path information update notification based on a distance and a time threshold for triggering the path information update notification based on a time to a communication apparatus; and
a receiver configured to receive an RRC reconfiguration complete message including information indicating that the path information is available from the communication apparatus in response to transmission of the RRC reconfiguration message, in which
the transmitter transmits a UE information request message including configuration information regarding report of the path information to the communication apparatus,
the receiver receives a UE information response message including the path information from the communication apparatus in response to transmission of the UE information request message, and
the receiver receives a UE assistance information message that includes the information indicating that the path information is available and is based on determination based on the distance threshold from the communication apparatus regardless of configuration of the time threshold.

### Supplementary Note 5

The base station according to supplementary note 4, in which
when a three-dimensional distance between location information of the path information transmitted by the communication apparatus and latest location information held by the communication apparatus exceeds the distance threshold, the receiver receives the UE assistance information message including the information indicating that the path information is available from the communication apparatus.

### Supplementary Note 6

The base station according to supplementary note 4 or 5, in which
even when not receiving the UE assistance information message that includes the information indicating that the path information is available and is based on the determination based on the distance threshold, the receiver receives the UE assistance information message that includes the information indicating that the path information is available and is based on determination based on the time threshold, from the communication apparatus.

### Supplementary Note 7

A communication method performed by a communication apparatus, the communication method including:
a step of receiving a radio resource control (RRC) reconfiguration message including information for configuring a distance threshold for triggering path information update notification based on a distance and a time threshold for triggering the path information update notification based on a time, from a base station;
a step of transmitting an RRC reconfiguration complete message including information indicating that the path information is available to the base station in response to reception of the RRC reconfiguration message;
a step of receiving a UE information request message including configuration information regarding report of the path information, from the base station;
a step of transmitting a UE information response message including the path information to the base station in response to reception of the UE information request message; and
a step of transmitting a UE assistance information message including the information indicating that the path information is available to the base station based on determination based on the distance threshold regardless of configuration of the time threshold.

### Supplementary Note 8

The communication method according to supplementary note 7, in which
in the step of transmitting the UE assistance information message, when a three-dimensional distance between location information of the transmitted path information and latest location information held by the communication apparatus exceeds the distance threshold, the UE assistance information message including the information indicating that the path information is available is transmitted to the base station.

### Supplementary Note 9

The communication method according to supplementary note 7 or 8, in which
in the step of transmitting the UE assistance information message, even when not transmitting the UE assistance information message including the information indicating that the path information is available by the determination based on the distance threshold, the UE assistance information message including the information indicating that the path information is available is transmitted to the base station based on determination based on the time threshold.

### Supplementary Note 10

A communication apparatus, including:
a transmitter configured to transmit path information regarding a planned path of the communication apparatus to a base station; and
a controller configured to determine whether or not to notify the base station of path information update based on a time difference configured from the base station when timestamp report based on the path information is configured, in which
even when the timestamp report is configured, the controller determines whether or not to notify of the path information update based on a distance difference configured from the base station.

### Supplementary Note 11

The communication apparatus according to supplementary note 10, further including:
a receiver configured to receive at least one of a distance threshold for configuring the distance difference and a time threshold for configuring the time difference from the base station, in which
the controller determines to notify of the path information update when a calculated distance difference calculated based on a new path of the communication apparatus exceeds the distance threshold, or when a calculated time difference calculated based on a planned time of the new path of the communication apparatus exceeds the time threshold.

### Supplementary Note 12

The communication apparatus according to supplementary note 11, in which
when the calculated distance difference exceeds the distance threshold, the controller determines to notify of the path information update without performing the determination based on the time difference configured from the base station.

### Supplementary Note 13

The communication apparatus according to supplementary note 12, in which
when the calculated time difference exceeds the time threshold, the controller determines to notify of the path information update without performing the determination based on the distance difference configured from the base station.

### Supplementary Note 14

The communication apparatus according to any one of supplementary notes 10 to 13, further including:
a receiver configured to receive a distance threshold for configuring the distance difference and a time threshold for configuring the time difference, from the base station, in which
the controller determines to notify of the path information update when a calculated distance difference calculated based on a new path of the communication apparatus exceeds the distance threshold and when a calculated time difference calculated based on a planned time of the new path of the communication apparatus exceeds the time threshold.

### Supplementary Note 15

The communication apparatus according to supplementary note 14, in which
when the calculated distance difference does not exceed the distance threshold, the controller determines not to notify of the path information update without performing the determination based on the time difference configured from the base station.

### Supplementary Note 16

The communication apparatus according to any one of supplementary notes 10 to 15, in which
the controller performs the determination based on the distance difference configured from the base station without performing the determination based on the time difference configured from the base station when the timestamp report based on the path information has not been performed.

### Supplementary Note 17

A communication method performed by a communication apparatus, the communication method including:
a step of transmitting path information regarding a planned path of the communication apparatus to a base station; and
a step of determining whether or not to notify the base station of path information update based on a time difference configured from the base station when timestamp report based on the path information is configured, in which
in the determining step, it is determined whether or not to notify of the path information update based on a distance difference configured from the base station even when the timestamp report is configured.

1. A communication apparatus, comprising:
a receiver configured to receive a radio resource control (RRC) reconfiguration message including information for configuring a distance threshold for triggering path information update notification based on a distance and a time threshold for triggering the path information update notification based on a time, from a base station; and
a transmitter configured to transmit an RRC reconfiguration complete message including information indicating that the path information is available to the base station in response to reception of the RRC reconfiguration message, wherein
the receiver is configured to receive a UE information request message including configuration information regarding report of the path information, from the base station,
the transmitter is configured to transmit a UE information response message including the path information to the base station in response to reception of the UE information request message, and
the transmitter is configured to transmit a UE assistance information message including the information indicating that the path information is available to the base station based on determination based on the distance threshold regardless of configuration of the time threshold.

2. The communication apparatus according to claim 1, wherein
in a case where a three-dimensional distance between location information of the transmitted path information and latest location information held by the communication apparatus exceeds the distance threshold, the transmitter is configured to transmit the UE assistance information message including the information indicating that the path information is available to the base station.

3. The communication apparatus according to claim 1, wherein
in a case where the transmitter does not transmit the UE assistance information message including the information indicating that the path information is available by the determination based on the distance threshold, the transmitter is configured to transmit the UE assistance information message including the information indicating that the path information is available to the base station based on determination based on the time threshold.

4. The communication apparatus according to claim 1, comprising
a controller configured to perform retransmission control to transmit the information indicating that the path information is available, in a case where an acknowledgement for the RRC reconfiguration complete message has not been received from the base station even after a designated duration has elapsed since the RRC reconfiguration complete message was transmitted.

5. The communication apparatus according to claim 4, wherein
the controller cancels the retransmission control, in a case where the acknowledgement is received before the predetermined duration elapses.

6. The communication apparatus according to claim 4, wherein
the acknowledgement is transmitted at a lower layer than an RRC layer.

7. The communication apparatus according to claim 4, wherein
the receiver is configured to receive a timer value indicating the designated duration from the base station, and
the controller is configured to:
start a timer with the timer value set for the timer, based on transmission of the RRC reconfiguration complete message; and
perform the retransmission control based on an expiration of the timer.

8. The communication apparatus according to claim 4, wherein
the controller is configured to consider that the communication apparatus is permitted to transmit a message at any time as a message including the information indicating that the path information is available, in a case where the timer value is received.

9. A base station, comprising:
a transmitter configured to transmit a radio resource control (RRC) reconfiguration message including information for configuring a distance threshold for triggering path information update notification based on a distance and a time threshold for triggering the path information update notification based on a time to a communication apparatus; and
a receiver configured to receive an RRC reconfiguration complete message including information indicating that the path information is available from the communication apparatus in response to transmission of the RRC reconfiguration message, wherein
the transmitter is configured to transmit a UE information request message including configuration information regarding report of the path information to the communication apparatus,
the receiver is configured to receive a UE information response message including the path information from the communication apparatus in response to transmission of the UE information request message, and
the receiver is configured to receive a UE assistance information message that includes the information indicating that the path information is available and is based on determination based on the distance threshold from the communication apparatus regardless of configuration of the time threshold.

10. The base station according to claim 9, wherein
in a case where a three-dimensional distance between location information of the path information transmitted by the communication apparatus and latest location information held by the communication apparatus exceeds the distance threshold, the receiver is configured to receive the UE assistance information message including the information indicating that the path information is available, from the communication apparatus.

11. The base station according to claim 9, wherein
in a case where the UE assistance information message that includes the information indicating that the path information is available and is based on the determination based on the distance threshold is not received, the receiver is configured to receive the UE assistance information message that includes the information indicating that the path information is available and is based on determination based on the time threshold, from the communication apparatus.

12. The base station according to claim 9, wherein
the receiver is configured to receive the information indicating that the path information is available, from the communication apparatus which does not receive from the base station even after a designated duration has elapsed since the RRC reconfiguration complete message was transmitted, and
the information indicating that the path information is available is transmitted by the communication apparatus to perform retransmission control.

13. A communication method executed by a communication apparatus, the communication method comprising:
a step of receiving a radio resource control (RRC) reconfiguration message including information for configuring a distance threshold for triggering path information update notification based on a distance and a time threshold for triggering the path information update notification based on a time, from a base station;
a step of transmitting an RRC reconfiguration complete message including information indicating that the path information is available to the base station in response to reception of the RRC reconfiguration message;
a step of receiving a UE information request message including configuration information regarding report of the path information, from the base station;
a step of transmitting a UE information response message including the path information to the base station in response to reception of the UE information request message; and
a step of transmitting a UE assistance information message including the information indicating that the path information is available to the base station based on determination based on the distance threshold regardless of configuration of the time threshold.

14. The communication method according to claim 13, wherein
in the step of transmitting the UE assistance information message, in a case where a three-dimensional distance between location information of the transmitted path information and latest location information held by the communication apparatus exceeds the distance threshold, the UE assistance information message including the information indicating that the path information is available is transmitted to the base station.

15. The communication method according to claim 13, wherein
in the step of transmitting the UE assistance information message, in a case where the UE assistance information message including the information indicating that the path information is available by the determination based on the distance threshold is not transmitted, the UE assistance information message including the information indicating that the path information is available is transmitted to the base station based on determination based on the time threshold.

16. The communication method according to claim 13, further comprising
a step of performing retransmission control to transmit the information indicating that the path information is available, in a case where an acknowledgement for the RRC reconfiguration complete message has not been received from the base station even after a designated duration has elapsed since the RRC reconfiguration complete message was transmitted.
